(19) United States
(12) Patent Application Publication
(10) Pub. No.: US 2024/0172095 A1
(43) Pub. Date: May 23, 2024

(54) Radio Network Node, User Equipment and Methods Performed Therein

(71) Applicant: Telefonaktiebolaget LM Ericsson (publ), Stockholm (SE)

(72) Inventors: Christofer Lindheimer, Vadstena (SE); Mai-Anh Phan, Herzogenrath (DE); Oscar Ohlsson, Bromma (SE); Hernán Felipe Arraño Scharager, Täby (SE); Miguel Angel Garcia Martin, Pozuelo de Alarcon (Madrid) (ES); Peter Hedman, Helsingborg (SE)

(21) Appl. No.: 18/551,212

(22) PCT Filed: Mar. 29, 2022
(86) PCT No.: PCT/SE2022/050308

§ 371 Date: Sep. 19, 2023

Related U.S. Application Data
(60) Provisional application No. 63/167,165, filed on Mar. 29, 2021.

(51) Int. Cl. H04W 48/10; H04W 8/26; H04W 48/18

(52) U.S. Cl. CPC H04W 48/10; H04W 8/265; H04W 48/18

(57) ABSTRACT

A method performed by a radio network node (12) for handling communication in a wireless communications network. The radio network node (12) configures a UE (10) with a mapping, wherein the mapping maps a name indication to a GID, and/or a type indication of a type of service offered by one or more networks identified by the GID.

### TECHNICAL FIELD

Embodiments herein relate to a radio network node, a user equipment (UE) and methods performed therein regarding wireless communication. Furthermore, a computer program product and a computer-readable storage medium are also provided herein. In particular, embodiments herein relate to handling communication, such as handling or controlling access to a radio network node, e.g., a non-public network for a service, in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate, e.g., enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and present and coming 3GPP releases, such as New Radio (NR) and extensions, are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

3GPP is currently working on Release 17 enhancements to first specifications of the 5G system of Release (Rel) 15 and/or 16. These types of enhancements are made to functionality that was introduced in early releases of the 5G specification.

One such functionality is Non-Public Networks, also known as NPNs, that was introduced in Release 16.

3GPP introduced support for two non-public networks deployment options from Release 16. The first NPN option outlines how operators could support non-public networks or dedicated deployments by associating them directly to the operator network. Such improvements resulted in solutions for what is commonly referred to as Public Network Integrated NPNs (PNI-NPN).

The second NPN option is the stand-alone NPN, or SNPN for short. In almost all aspects, this is a network that carries the same functionality and characteristics as the more commonly known Public Land Mobile Network (PLMN), but it differs in some aspects, e.g., an SNPN is identified by an SNPN identifier (ID) rather than a PLMN ID. The SNPN ID is composed of a PLMN ID and a Network ID (NID). Additionally, there is no support for mobility between SNPNs, in the same way as is possible between, equivalent, PLMNs.

In a cell, herein understood as an entity that sends a broadcast, e.g., system information block one (SIB1) message, there can be one or many NPNs or PLMNs sharing the resources, e.g., frequency and processing capabilities, and such situations are commonly referred to as RAN sharing.

One and the same System Information Block (SIB) broadcast can thus represent different networks and for each of these, there can be specific identifiers such as Cell IDs, i.e., different “logical” cells, and different Tracking Area Codes (TACs).

To account also for sharing between PLMNs and NPNs, between PLMNs only or between NPNs only, two different lists have been defined in the broadcast, one for listing NPNs, comprising both SNPNs and PNI-NPNs (or Closed Access Group (CAG) cells), referred to as npn-IdentityInfoList and one for listing PLMNs, referred to as plmn-IdentityList, see below.

These lists are defined in 3GPP Technical Specification (TS) 38.331 [2] and are broadcast in SIB1.

```
  -- ASN1START
  -- TAG-CELLACCESSRELATEDINFO-START
```

| CellAccessRelatedInfo ::= | SEQUENCE { | |
|---|---|---|
| plmn-IdentityList | PLMN-IdentityInfoList, | |
| cellReservedForOtherUse | ENUMERATED {true} | OPTIONAL, -- |

```
Need R
    ...,
    [[
```

| | | |
|---|---|---|
| cellReservedForFutureUse-r16 | ENUMERATED {true} | OPTIONAL, |

-- Need R

| | | |
|---|---|---|
| npn-IdentityInfoList-r16 | NPN-IdentityInfoList-r16 | OPTIONAL -- Need |

```
R
    ]]
  }
  -- TAG-CELLACCESSRELATEDINFO-STOP
  -- ASN1STOP
```

The different lists allow an operator, PLMN-specific or, e.g., neutral host operator, to support a number of different PLMNs and NPNs in the broadcast. Abstract Syntax Notation (ASN; ASN1; ASN.1) used herein, e.g., as code snippets, describes what information is/may be communicated in each referenced scenario.

An NPN, identified by a PLMN ID+CAG ID or a SNPN ID, can further be associated with Human Readable Network Name (HRNN) broadcast in SIB10 to facilitate manual network selection. The below is the ASN.1 for system information block ten (SIB10), including an HRNN list.

```
  SIB10 information element
  -- ASN1START
  -- TAG-SIB10-START
```

| SIB10-r16 ::= | SEQUENCE { | |
|---|---|---|
| hrnn-List-r16 | HRNN-List-r16 | OPTIONAL, -- |

Need R

| | | |
|---|---|---|
| lateNonCriticalExtension | OCTET STRING | OPTIONAL, |

```
    ...
  }
```

| | |
|---|---|
| HRNN-List-r16 ::= | SEQUENCE (SIZE (1..maxNPN-r16)) OF HRNN-r16 |
| HRNN-r16 ::= | SEQUENCE { |
| hrnn-r16 | OCTET STRING (SIZE (1.. maxHRNN-Len-r16)) |

```
OPTIONAL -- Need R
  }
  -- TAG-SIB10-STOP
  -- ASN1STOP
```

SIB10 field descriptions

```
  HRNN-List
  The same amount of HRNN elements as the number of NPNs in
  SIB1 are included.
The n-th entry of HRNN-List contains the human readable network
name of the n-th NPN of SIB1. The hrnn in the corresponding entry in
HRNN-List is absent if there is no HRNN associated with the given NPN.
```

### NPN Enhancements

For NPN, the enhancements currently addressed are described in 3GPP technical report (TR) 23.700-07 [1], which outlines several key issues, which can be translated into enhancement areas.

SNPN Access Using Credentials from a Separate Entity (Key Issue #1)

Key issue #1 describes a situation when a UE can access an SNPN using credentials not from the SNPN itself, but from another, separate entity, which can be another Service Provider, SP, or Subscription Provider.

The challenges related to KI #1 are described in TR 23.700-07 [1] as:

“This key issue aims at addressing the following points for SNPN along with subscription owned by an entity separate from the SNPN:
How to identify the separate entity providing the subscription.
Network selection enhancements, including UEs with multiple subscriptions;
E.g. how does the UE discover and select an SNPN which provides authentication in an external entity;
Architecture enhancements needed to support multiple separate entities, e.g.:
What are the interfaces exposed and/or used by SNPN and the separate entity;
What is the architecture and solution for a UE accessing a separate entity via SNPN access network;
How to exchange authentication signalling between the SNPN and the separate entity, including:
Authentication by the PLMN, based on PLMN identities and credentials, for access to the SNPN;
Authentication via SNPN to separate entity based on non-3GPP identities (e.g. non- International Mobile Subscriber Identity (IMSI)) and credentials;
Mobility scenarios, including service continuity, for:
UE moving from SNPN #1 with separate entity #1 to SNPN #2 with separate entity #1 available; and
UE moving between SNPN #1 (where separate entity=PLMN) and PLMN.

NOTE: Security aspects should be defined by SA WG3.”

3GPP TR 23.700-07 [1] indicates the following relevant conclusions for KI #1:
Group ID as a specific case of SNPN ID reusing SNPN ID encoding in TS 23.003 [15], where
SIB will be enhanced as follows, for SNPN only:
Indication that “access using credentials from a separate entity is supported”
Optionally, supported Group IDs (GIDs)
Optionally, an indication whether the SNPN allows registration attempts from UEs that are not explicitly configured to select the SNPN

In the following, we explain the above conclusions for KI #1.

In order for a UE to discover and select an SNPN which provides authentication in an external entity, i.e. the service/subscriber provider (SP), TR 23.700-07 [1] concludes that SNPNs need to indicate these new functionalities to UEs. Otherwise, the UEs would not know that they can access these networks with the credentials they possess from the service/subscriber provider.

Furthermore, it was also concluded to allow an SNPN to indicate whether it allows registration attempts from UEs that are not explicitly configured to select this SNPN, hence enabling UEs to perform blind registration attempts, which eventually, may fail if the SNPN does not have means to authenticate the UE.

FIG. 1a shows an association between SNPN and, group of, SPs, the latter being identified by a GID.

Finally, it was concluded to introduce a Group ID (herein referred to as GID), which provides the aggregation of one or more SPs, to constitute an easy association between (the group of) SPs and SNPNs as illustrated in FIG. 1a. In 3GPP discussions the GID was at a later stage also referred to as “Group ID for network selection”, or GIN for short to be more specific what this GID is used for. In addition, the SP is also referred to as “Credentials Holder (CH)”.

The GID is mainly intended to be used by the UE during the network selection procedure and should associate the UE credentials from the SP with various SNPNs that support access using such credentials.

In this sense, and in specific cases where a SNPN does not hinder registration attempts from UEs that are not explicitly configured to select the network, the use of GIDs could also reduce the number of opportunistic registration attempts. The thinking behind the GID or GIN is that it would be easier to handle changing support for access of a certain SP, or that it would be easier also for SNPNs to advertise what SPs are supported, especially in scenarios in which the number of these is large. Thus, the GID is bridging the association between SNPNs and service providers in a many-to-many possible relationship that can change without the need to change the UE configuration which would list all the SNPNs supporting access using credentials from any of the SPs identified by the GID.

In summary, the GIN is an identifier of a collection of Subscription Providers (SP).

The use of GIDs is exemplified in the TR as follows:

“Home SP Group examples include:
National operating companies of a multi-national operator
By broadcasting the Home SP Group ID assigned to the multi-national operator, a V-SNPN can enable the UEs from all the national operating companies of the multi-national operator to select the V-SNPN (instead of having to broadcast the Home SP IDs of each of the national operating companies, which may also exceed the number of Home SP IDs supported by SIB).
Home SPs that are connected to an interconnection provider
Typically mobile operators have direct interconnections and agreements only with large partner networks.
For the large amount of small partner networks, mobile operators typically use the services of an interconnection provider that provides interconnection with a large amount of partner networks while avoiding the need for bilateral agreements and interconnections.
By broadcasting the Home SP Group ID assigned to the interconnection provider, a V-SNPN can enable the UEs from all the Home SPs connected to the interconnection provider to select the V-SNPN (instead of having to broadcast the IDs of each of the Home SPs, which may also exceed the number of Home SP IDs supported by SIB) while also avoiding the need for the Home SPs to maintain an accurate list of all the supported V-SNPNs.

NOTE 1: The Home SP Group ID is assumed to be globally unique or self-managed. Assignment of a unique Home SP Group ID is beyond the scope of 3GPP.

”

The “Home SP” used in the cited text above is herein simply referred to as SP. The V-SNPN used in the text above is the visited network from the UE's or SP's point of view. It is generally referred to as SNPN herein. The “Home SP Group ID” used above is simply referred to as GID.

As described in 3GPP TR 23.700-07 [1], clause 8.1.4, the UE is pre-configured with the parameters below which assist the UE in the network selection:

“
UE configuration:
User-controlled prioritized list of preferred SNPNs.
Separate entity controlled prioritized list of preferred SNPNs.
Separate entity-controlled prioritized list of Group IDs (GIDs).

NOTE 3: The UE may also only be configured with the separate entity-controlled prioritized list of preferred SNPNs or only the separate entity-controlled prioritized list of Group IDs.”

The pre-configuration is performed by the CN on the Non-Access Stratum (NAS) layer, e.g., by the service provider and/or credentials holder of the UE. The configuration may at any time be updated by the CN.

As described in 3GPP TR 23.700-07 [1], clause 6.2.2.3, the Home SP Group IDs, i.e., the GIDs, are broadcast per SNPN:

“NG-RAN nodes which support access using Home SP credentials broadcast the following information per SNPN: [ . . . ] List of supported Home SP Group IDs”

As mentioned above, the GID may identify one or multiple SPs and is used for network selection.

UE behavior for GID usage.

In the 3GPP TR 23.700-07 [1], the following UE behavior is captured:
UE selects an available and allowable SNPN which broadcasts “access using credentials from a separate entity is supported” indication and a GID contained in the separate entity-controlled list (if available)

In other words, a UE that is equipped with credentials from a service provider that can be used to access certain SNPNs, is thus also configured with a GID. When the UE is moving around, and performing network selection, it can scan and detect available networks. The UE then detects SNPN ID(s) and GID(s) broadcast by the SNPN.

The UE decodes the available networks IDs in the cell from the npn-IdentityInfoLists and it also detects any list with GIDs and its association to these networks.

Now, the UE may select an SNPN that provides authentication to an SP that is part of the GID, by comparing the GIDs it is configured with, with the GIDs broadcast by the SNPN.

The UE network selection procedure would then select one of the SNPNS it is allowed to access, given the credentials the UE is configured with.

Manual network selection.

In the TR, the following is captured for manual selection:
For manual SNPN selection the UE presents all available SNPNs, which broadcast the “access using credentials from a separate entity is supported” indication.

It has also been proposed in 3GPP to broadcast a human readable name for the GIDs similar to HRNN used for NPNs. The human readable name for the GID, herein referred to as a Human Readable Group Name (HRGN), would be displayed to the user during the manual network selection so that the user can identify the group of SPs associated with an SNPN.

### UE Onboarding (KI #4)

3GPP TR 23.700-07 [1] also discussed another key issue, labeled KI #4:

Architecture and solutions to support UE onboarding and provisioning for the NPN. The term “Onboarding” refers to enabling connectivity to the UE for realizing remote provisioning, and in some cases the term “Onboarding” includes both enabling the connectivity as well as the remote provisioning of the UE with NPN credentials. This key issue includes some common aspects such as:
Means for a UE, that is verifiably secure and uniquely identifiable to 5GS, for onboarding and remote provisioning;
Support of exposure via APIs to support UE onboarding and remote provisioning, if required.
How does the UE discover and select the onboarding SNPN before UE NPN credentials and other information to enable UE to get 3GPP connectivity are provisioned.

FIG. 1b shows a UE onboarding procedure and GID addition.

During the Release 17 3GPP SA2 working group study item phase on NPN enhancements, it was proposed that the GID can also be used to indicate a group of manufacturers, which provide UEs with default credentials. SNPNs that support onboarding using default credentials from these manufacturers, would broadcast an onboarding indication and the GID identifying these manufacturers. It should be noted that no agreements were made in detail which nodes the GID would identify for this usage of GID for onboarding of UEs to an SNPN.

The GID usage included in clause 8.4.1 of the updated 3GPP TR 23.700-07 v2.0.0 [6]:

“

[ . . . ] The UE may or may not be pre-configured with O-SNPN network selection information (e.g. O-SNPN network identifiers or Group ID(s)). The O-SNPN network selection information can assist the UE such that the UE either preferably or exclusively select an O-SNPN corresponding to the O-SNPN network identifiers or Group ID(s).

NOTE 2: The format of the pre-configured information assisting the UE for O-SNPN selection is not specified.

NOTE 3: The Group ID(s) in the SIB that UE can use for selecting an O-SNPN are the same as the Group ID(s) in the SIB that the UE uses for SNPN selection as part of KI #1.

”

Key Issues #1 and #4 in 3GPP TR 23.700-07 [1] are highly related. On comparing the problems and solutions addressed by both key issues, for accessing an SNPN using external credentials (KI #1), the UE has valid network credentials for the external entity, while for onboarding (KI #4), such network credentials still need to be provisioned to the UE as part of the UE onboarding procedure. Thus, the external entities referred to in KI #1 and in KI #4 are completely different. However, they can in principle be identified by the same GID that assists the UE in the network selection.

Two solutions have been proposed:
a) Introduce a GID list for KI #1, and a separate GID list of KI #4.
b) Differentiate the IDs for KI #1 and KI #4 and ensure there is no overlapping between them.

In the future it is likely that other services are added and may then also need to be identified/referenced.

### SUMMARY

As part of developing embodiments here one or more problems were first identified. As described in the background section, there may be multiple networks available for a UE, and each network, e.g. an SNPN, may provide multiple services to the group of SPs identified by a GID, e.g., access to the network using external credentials (KI #1) and onboarding (KI #4). It is also possible that additional services are defined in the future. For a UE interested in a particular service to select a suitable network, the service types offered by the network must be identifiable from the system information broadcast. Furthermore, for manual network selection the service type may be presented in a form that may be understood by the user, e.g., human user.

One may represent additional services by, e.g., a service ID or similar representation, which is associated with a Group ID, and broadcast of such service IDs. Alternatively, GID encoding approaches may be introduced to minimize the number of bits for the GID encoding using different GID assignment modes.

Embodiments herein address the latter problem, i.e., how the service types may be conveyed to the user during manual network selection or based on preconfigured preferences. In addition, when enabling a UE to select a larger range of networks based on available services there may also be a need to consider the other aspects such as how the services are paid for and the price for the services and other characteristics.

An object herein is to provide a mechanism to handle communication in an efficient manner in the wireless communications network.

According to an aspect the object is achieved, according to embodiments herein, by providing a method performed by a radio network node for handling communication in a wireless communications network. The radio network node configures a UE with a mapping, wherein the mapping maps a name indication, such as a Human readable service information (HRSI), to a GID and/or a type indication of a type of service offered by one or more networks identified by the GID. The name indication may indicate additional characteristics of the service such as how the services are paid for and/or a price for the services and other characteristics.

According to another aspect the object is achieved, according to embodiments herein, by providing a method performed by a user equipment for handling communication in a wireless communications network. The user equipment is configured with a mapping, wherein the mapping maps a name indication, such as the HRSI, to a GID and/or a type indication of a type of service offered by one or more networks identified by the GID.

According to yet another aspect the object is achieved, according to embodiments herein, by providing a radio network node and UE configured to perform the methods, respectively.

Thus, according to an aspect the object is achieved, according to embodiments herein, by providing a radio network node for handling communication in a wireless communications network. The radio network node is configured to configure a UE with a mapping, wherein the mapping maps a name indication, such as the HRSI, to a GID and/or a type indication of a type of service offered by one or more networks identified by the GID.

According to yet another aspect the object is achieved, according to embodiments herein, by providing a user equipment for handling communication in a wireless communications network. The user equipment is adapted to be configured with a mapping, wherein the mapping maps a name indication to a GID and/or a type indication of a type of service offered by one or more networks identified by the GID.

It is furthermore provided herein a computer program product comprising instructions, which, when executed on at least one processor, cause the at least one processor to carry out the method above, as performed by the radio network node and UE, respectively. It is additionally provided herein a computer-readable storage medium, having stored thereon a computer program product comprising instructions which, when executed on at least one processor, cause the at least one processor to carry out the method above, as performed by the UE or radio network node, respectively.

Embodiments herein disclose a name indication, also referred to as HRSI, that is associated to each of the service types offered by a network identified by the GID and/or the GID. The network may offer such services directly to UEs with a subscription for this network or may offer such services to UEs with a relation to one or more external entities. The HRSI and the mapping to the type indication may either be broadcasted in system information or be pre-configured in the UE.

The HRSIs may also include information related to additional characteristics such as charging, time, payment options, other characteristics allowing the UE to take into consideration even more information for purposes of selecting service and/or network.

Hence, embodiments herein provide a mechanism to efficiently handle communication in the wireless communications network.

### BRIEF DESCRIPTION OF THE DRAWINGS

Embodiments will now be described in more detail in relation to the enclosed drawings, in which:

FIG. 1a shows an architecture according to prior art;

FIG. 1b shows an architecture according to prior art;

FIG. 2 shows a wireless communications network according to embodiments herein;

FIG. 3 shows a combined signalling scheme and flow chart according to embodiments herein;

FIG. 4 shows a flow chart depicting a method performed by a radio network node according to embodiments herein;

FIG. 5 shows a flow chart depicting a method performed by a user equipment according to embodiments herein;

FIG. 6 shows an exemplary 5G communication system comprising 5GC and NG-RAN;

FIG. 7 shows a mapping according to embodiments herein;

FIG. 8 illustrates a mapping according to embodiments herein;

FIG. 9 illustrates a mapping according to embodiments herein;

FIG. 10 shows a schematic overview depicting a UE network selection behaviour based on broadcast according to embodiments herein;

FIG. 11 shows a block diagram depicting radio network nodes according to embodiments herein;

FIG. 12 shows a block diagram depicting a UE according to embodiments herein;

FIG. 13 schematically illustrates a telecommunication network connected via an intermediate network to a host computer;

FIG. 14 is a generalized block diagram of a host computer communicating via a base station with a user equipment over a partially wireless connection; and

FIGS. 15-18 are flowcharts illustrating methods implemented in a communication system including a host computer, a base station and a user equipment.

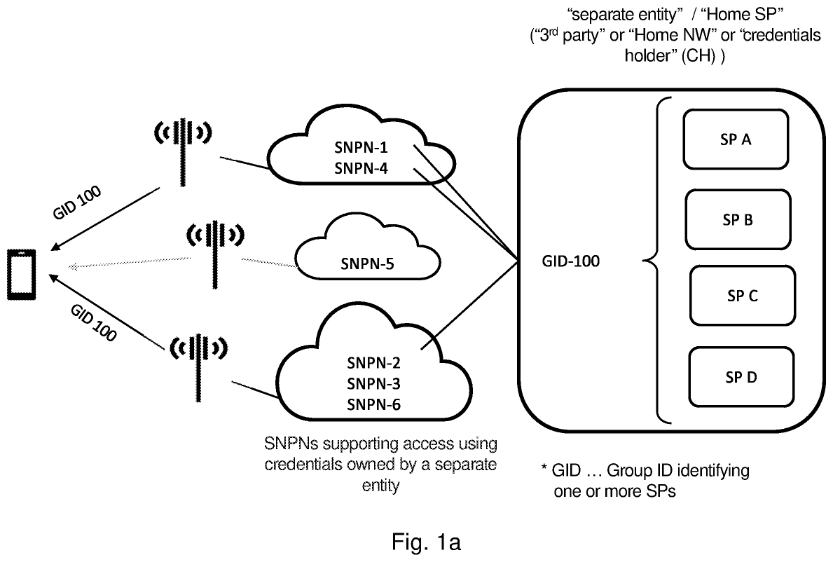

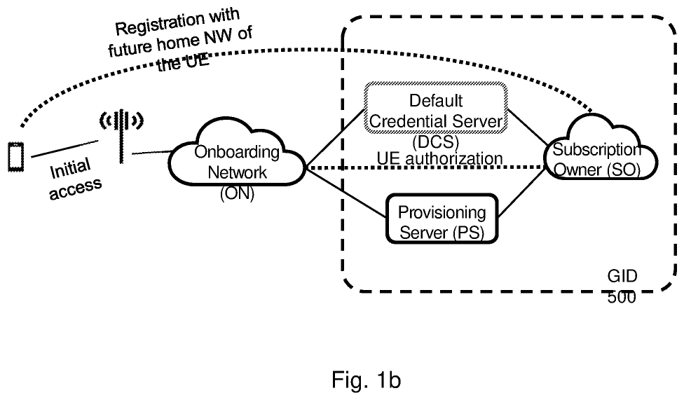

### DETAILED DESCRIPTION

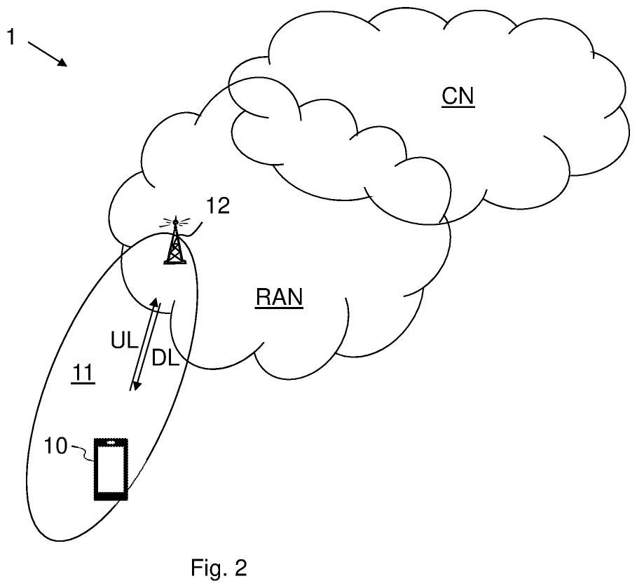

Embodiments herein relate to wireless communications networks in general. FIG. 2 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a NR context, however, embodiments are also applicable in further development of existing wireless communications systems such as e.g. LTE or WCDMA.

In the wireless communications network 1, a UE 10, exemplified herein as a wireless device such as a mobile station, a non-access point (non-AP) station (STA), a STA and/or a wireless terminal, is comprised communicating via e.g., one or more Access Networks (AN), e.g., RAN, to one or more CNs. It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a radio network node 12 providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the radio network node depending e.g. on the first radio access technology and terminology used. The radio network node may be referred to as a serving radio network node wherein the service area may be referred to as a serving cell, and the serving network node communicates with the UE 10 in form of DL transmissions to the UE 10 and UL transmissions from the UE 10. It should be noted that a service area may be denoted as cell, beam, beam group or similar to define an area of radio coverage.

In the embodiments described herein the UE 10 is configured with a mapping between a name indication such as a HRSI and a GID and/or a type indication, also referred to as service type, of a type of service offered by one or more networks identified by a GID. The type indication is thus associated with an HRSI that may be displayed to the user of the UE 10 during, for example, manual network selection. The HRSI and the mapping to the type indication may be configured at the UE 10 and may either be broadcasted in system information, or be pre-configured in the UE 10. The HRSI may be provided such that it is readable e.g. for human users. The radio network node 12 may broadcast SI in the cell 11, wherein the SI comprises the mapping between the type indication and the name indication.

The name indication such as the HRSI allows the user to identify the services offered by a network in manual network selection. In this way the user can directly determine if a network is suitable or not and does not have to rely on trial and error which is more time and resource consuming.

The UE 10 may be pre-configured, and updated by the network, with the mapping of the type indication to HRSI. When the UE 10 reads the type indication, the UE 10 may use the HRSI associated to that type indication on a display for an end user of the UE 10. If interested, the user may thus manually select the network. A pseudo-manual selection may be enabled by the user configuring the UE 10 with wanted services, in, for example, a string format, and the UE 10 may use a user configured list to automatically search and select one or more networks that fulfil the user configured list.

The name indication may be broadcasted and broadcasting the name indication such as the HRSI rather than using a pre-configured name involves a higher signalling overhead but is more flexible since it allows the name indication to be adapted based on the network needs, e.g. the HRSI can be in a local language. Broadcasting the HRSI may also be more future proof since the UE 10 may display the HRSI even if a new service is added in the future. For pre-configured HRSI this may not be possible since pre-configuration may only be done for the services which are known beforehand, e.g., at UE manufacturing. Also, even if the UE 10 may be updated with new mapping information, the UE 10 may need to be registered to a network.

Allowing the HRSI to contain additional x21 characteristics such as pricing information and payment methods enables the user of the UE 10 to select networks without any prior business relation.

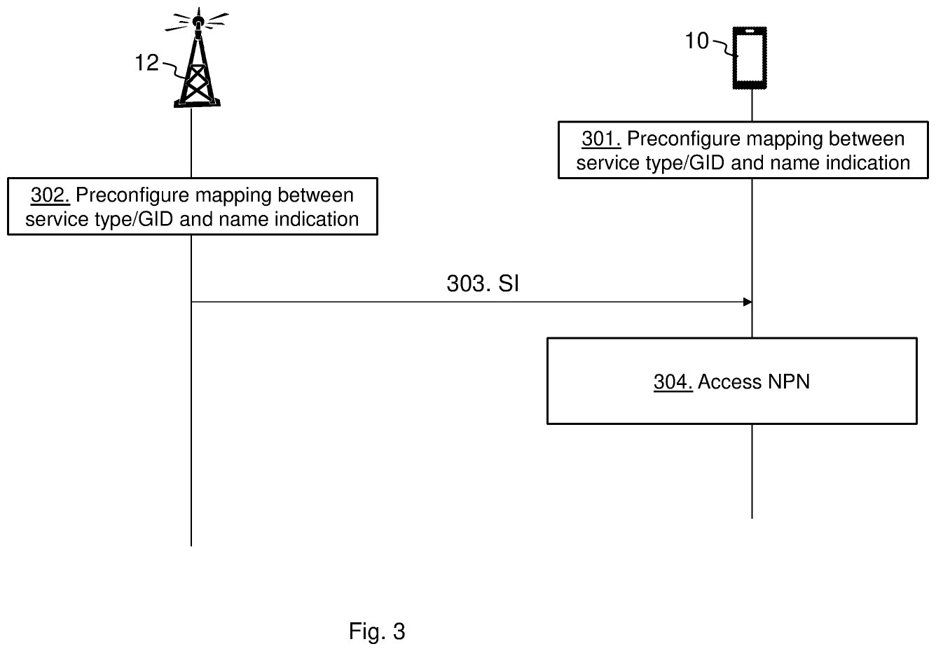

FIG. 3 is a combined signalling and flowchart scheme according to embodiments herein.

Action 301. The UE 10 may be preconfigured with the mapping between the type indication of a type of service and the name indication such as a HRSI. The HRSI and the mapping to the type indication may either be broadcasted in system information, pre-configured or configured in the UE 10. Hence, the UE 10 may be preconfigured with GID and/or one or more type indications represented by a list and/or a bitmap, mapped to one or more name indications such as a HRSI.

Action 302. The radio network node 12 is preconfigured with GID and/or one or more type indications, also referred to as type parameters, which may be represented by a list and/or a bitmap, mapped to the one or more name indications such as the HRSI.

Action 303. The radio network node 12 may transmit, for example, broadcast, SI, wherein the SI comprises the type indication and/or a GID, wherein the type indication indicates the type of service offered by one or more networks identified by the GID. The type indication and/or the GID is associated with the HRSI that can be displayed to the user of the UE 10 during manual network selection or used based on preconfigured preferences configured at the UE 10. As stated above the radio network node 12 may configure the UE 10 by transmitting the name indication and the mapping of the name indication to the type indication.

Action 304. The UE 10 may receive the SI and use the type indication, the GID and/or the name indication for accessing a network associated with the GID and/or the service type for which the UE 10 is configured. The network may be manually selected based on the information of the HRSI such as cost or other characteristics or automatically selected based on configured preferred characteristics of the name indication.

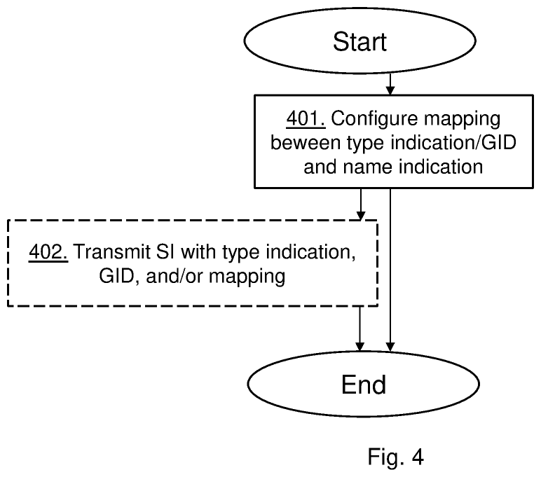

The method actions performed by the radio network node 12 for handling communication in the wireless communications network 1 according to embodiments herein will now be described with reference to a flowchart depicted in FIG. 4. The actions do not have to be taken in the order stated below but may be taken in any suitable order. Dashed boxes indicate optional features.

Action 401. The radio network node 12 configures the UE 10 with the mapping wherein the mapping maps the name indication such as the HRSI, to the GID and/or the type indication of a type of service offered by one or more networks identified by the GID. The radio network node 12 may configure the UE 10 by transmitting, e.g., in the SI or dedicated signalling, the name indication and the mapping between the name indication and the type indication and/or the GID. The name indication may comprise human readable service information, and/or additional characteristics such as start and end time, price, payment options, rating, etc.

Action 402. The radio network node 12 may transmit, for example, broadcast, the SI with the type indication and/or GID. The SI may comprise the mapping.

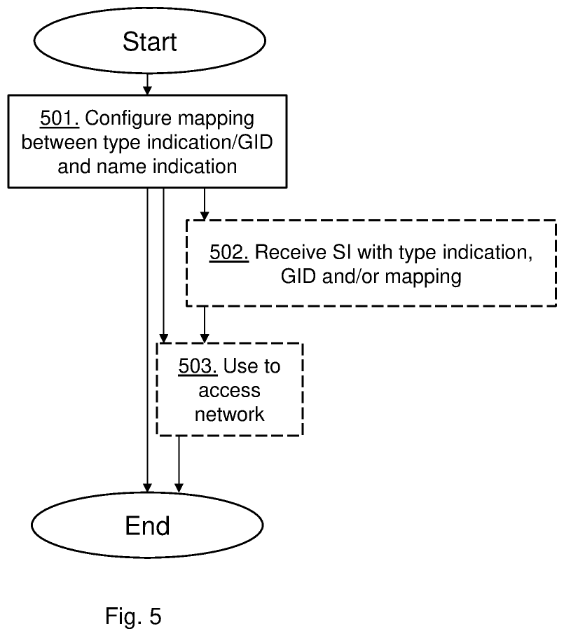

The method actions performed by the UE 10 for handling communication in the wireless communications network 1 according to embodiments herein will now be described with reference to a flowchart depicted in FIG. 5. The actions do not have to be taken in the order stated below, but may be taken in any suitable order. Dashed boxes indicate optional features.

Action 501. The UE 10 is configured, preconfigured or configured from the radio network node 12, with the mapping, wherein the mapping maps the name indication such as the HRSI, to the GID and/or the type indication of a type of service offered by one or more networks identified by the GID. The UE 10 may, for example, when the radio network node 12 configures the UE 10, receive, e.g., in the SI or dedicated signalling, the name indication and the mapping between the name indication and the type indication.

Action 502. The UE 10 may receive the SI with the mapping, the type indication and/or the GID. The name indication may comprise human readable service information, and/or additional characteristics such as start and end time, price, payment options, rating, etc.

Action 503. The UE 10 may then use the type indication, the GID and/or the name indication to access a network. The UE 10 may use the type indication, the GID and/or the name indication by selecting one of the networks based on the GID and/or the type indication, and the mapped name indication. The one of the networks may be manually selected based on the name indication. For example, the UE 10 may select one of the networks it is allowed to access, based on the GID(s) the UE 10 is configured with and type indication and the mapped name indication. For example, the UE 10 may select network which corresponds to the type indication and HRSI, for example, manually selected or selected based on configured preferences.

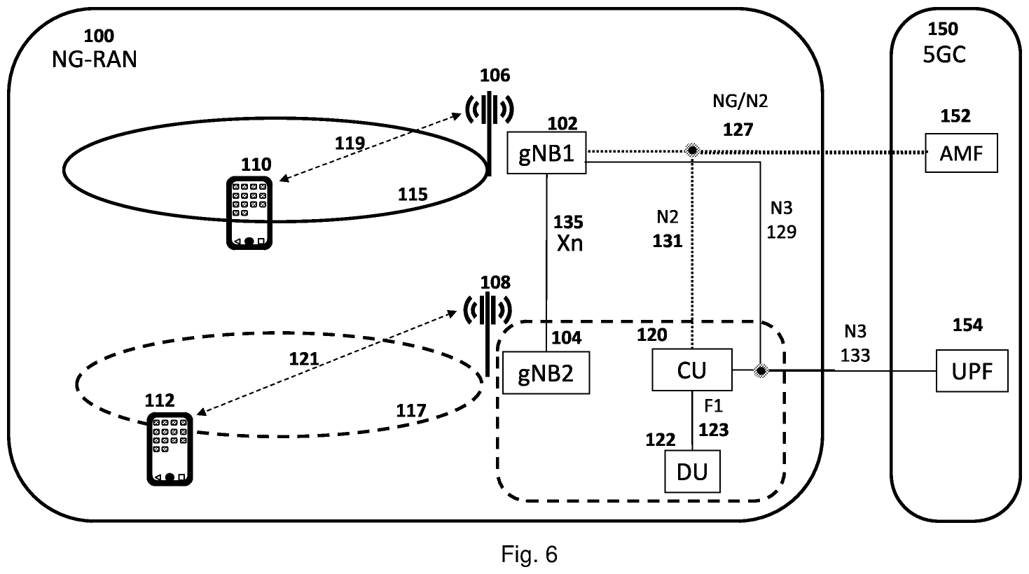

FIG. 6 shows an exemplary 5G communication system comprising fifth generation core (5GC) and NG-RAN.

FIG. 6 illustrates an exemplary communication system pursuant to 3GPP specifications for 5GC) 150 and 5G Radio Access Network or NG-RAN 100 as described in, e.g., 3GPP TS 23.501 [3], TS 38.300 [4] and TS 38.401 [5].

The 5G-RAN or NG-RAN consists of gNBs 102, 104 that connects to antenna elements 106, 108 via which wireless communication 119, 121 is possible to/from UEs 110, 112 within a certain coverage area 115, 117. The interface between the gNB 102, 104 and the UE 110, 112 is sometimes referred to as the Uu interface. Different gNBs can connect to each other via a direct interface referred to as Xn 135 interface. This interface is typically used for mobility between different gNBs, e.g., when UEs move between different coverage areas served by different gNBs. In FIG. 6 gNB2 104 is illustrated with additional details in how it may be built-up. A gNB may consist of a Central Unit (CU) 120 and at least one Distributed Unit (DU) 122. The CU 120 can connect with the DU 122 via an F1 interface 123. The gNBs 102, 104 are then connected to two different nodes in the 5G Core network, one for the user plane traffic and one for control plane traffic. The interface for control plane NG/N2 127, 131 towards an Access and Mobility management Function (AMF), 152 and the interface for user plane traffic N3, 129, 133 for communication towards a User Plane Function (UPF) 154. The standard describes, e.g., N5, N7, etc., to be the reference point between two nodes/end points, synonymous to interface as it is sometimes done also in specifications. The connection to the core network goes in the illustration via the CU in the gNB, as exemplified by gNB2 104 and CU 120. It is the role of the gNB to terminate the control signaling that establishes and controls the air interface connection towards the UE. It is further the role to be the communication point towards the radio access network 100 for the core network 150. While the interfaces have been denoted with, e.g., N5, N7 etc. in the figure (N+number) this is usually referring to a reference point between the different nodes, in this description the same denotations will be used to denote the interfaces between the entities in its entirety.

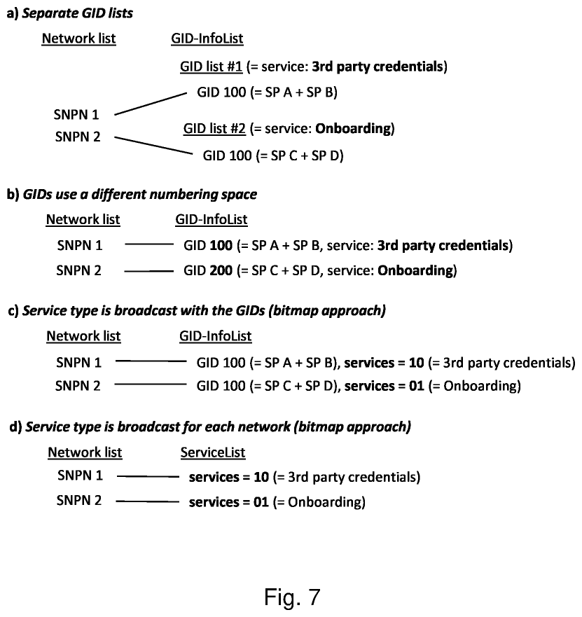

As mentioned above, a GID may be associated with one or several service types, e.g. authentication using external credentials (KI #1) or UE onboarding (KI #4). It is also possible that additional service types are defined in the future, which may be added to the GID or even to the network directly. To indicate the service type for a GID or a network there are several options that may be considered, see FIG. 7:
a) Separate GID lists are used for each service. For example, there could be one GID list for a service type such as authentication using external credentials (KI #1) and another GID list for a service type such as UE onboarding (KI #4).
b) Separate GIDs are used for different services. For example, SP A and B might use GID 100 for authentication using external credentials (KI #1) and GID 200 for UE onboarding (KI #4).
c) A service type indicator is broadcasted along each GID. The type indication, also referred to as a service type or a service type indicator, could e.g., be in the form of a bitmap where each bit represents a particular service, e.g. bit 0 represents authentication using external credentials (KI #1) and bit 1 represents UE onboarding (KI #4).
d) A list of networks per service or a list of services per network

Note that options ‘a’ and ‘b’ are generalizations of options ‘a’ and ‘b’ in the background section, and option ‘c’ is described as another embodiment. Option ‘d’ is applicable when the services are advertised by the network without associating them to a certain GID. This corresponds to the concept of simply indicating the supported services, e.g. for KI #1 this would be the <<Indication that “access using credentials from a separate entity is supported”>>, and for KI #4 (UE onboarding) this would be the “indication for Onboarding enabled in the SIB”.

Options ‘a’-‘d’ are illustrated in FIG. 7. In the examples in FIG. 7 it is assumed that the SNPN network list is broadcasted in SIB1, as is the case today, and the GID list are broadcasted in a separate SIB. The GIDs in the GID list are associated with one or more SNPNs in the SNPN list by, e.g., including the index of the associated SNPN as described in the related embodiments. In option ‘a’ there are two GID lists, one for the 3^{rd} party credentials service and one for the onboarding service. The term “3^{rd} party SP” refers to a credential holder (CH), different from the NPN, or vertical network in this example, and which provides the UE 10 with subscription credentials for granting access to a network. In option ‘b’ there is only one list, and the service type is instead integrated into the GID value, i.e. uses a different numbering space or in some way encoded into the GID value. In option ‘c’ there is also only one GID list and for every GID value there is a bitmap that indicates the services that the GID supports, in this example we use a 2-bit long bitmap to differentiate the above-mentioned services, while the actual bitmap can cover more services and even spare values for services to be defined at a later stage. In option ‘d’, there is no GID, but the supported services are associated directly to the SNPNs.

FIG. 7 shows options for indicating service type for GIDs (options ‘a’-‘c’)/networks (‘d’). Embodiments herein enable network selection using a HRSI, e.g., by mapping the HRSI to the type indication. There are two high level approaches that may be used to achieve this: (1) broadcasting the HRSI in system information; or (2) pre-coaqcvnfiguring the HRSI in the UE 10. The two approaches are described in more detail in the following sections.

Registration using 3^{rd} party credentials and onboarding are used herein as examples of service types offered by the network to the group of SPs, i.e., the GID.

New service type indications.

Embodiments herein are not limited to the examples listed above, but the same idea can be used for other service types introduced in the future, e.g., a concert or gaming service. For example, the network can indicate “Concert-A” or “Game-Y”. Such advertisement allows the UE 10 or the user of the UE 10 to explicitly learn which network provides access to the event the user may eventually get interested in.

Additional service information also referred to as additional characteristics.

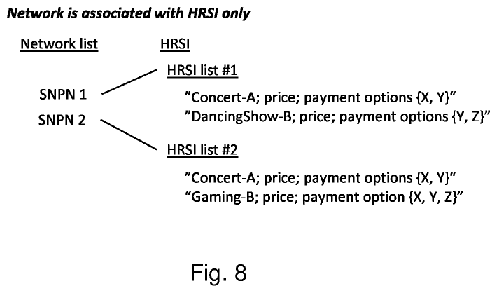

Furthermore, the name indication such as the HRSI may also include additional information or characteristics of the service that may be of interest to the user or the UE 10 besides the service name, for example start and end time, price, payment options, rating, etc. Such an example is illustrated in FIG. 8. In this example, it is assumed that the name indication is associated directly with the network, where one name indication may be used for each network, but embodiments herein are not restricted to this and one name indication may be associated with a GID, which in turn is associated to more than one network in a similar way as for other embodiments. If additional information, such as one or more additional characteristics, is included the name indication may be encoded using a more structured format e.g. JSON, XML, ASN.1 than a text string.

The one or more additional characteristics may comprise a price and/or payment method. When price for the service is included there may also be a payment method included such that the network selection may be based on lowest price service offerings that provides the possibility for payment using a method that the user prefers/supports, or the search result may be ordered by price and only show offers with the payment method the user prefers/supports. Examples of payment methods are type of credit card, Paypal, electronic currency, Voucher, Concert Ticket etc.

Broadcast of association between the name indication such as the HRSI and network without indicating a service type.

FIG. 8 shows a network list associated with HRSI using separate lists. Below is it shown an ASN.1 example for broadcasting of HRSI information. Here, a simple HRSI list is assumed per broadcasted network, but broadcasting optimizations can be applied as described in other embodiments. The payment details can then be translated into a structured format e.g. JSON, XML, etc.

| | |
|---|---|
| HRSI-List-r17 ::= | SEQUENCE (SIZE (1..maxServices-r17)) OF HRSI-r17 |

| | |
|---|---|
| HRSI-r17 ::= | SEQUENCE { |

| | |
|---|---|
| hrsn-r17 | HRSN-r17 OPTIONAL, -- |

Need R

| | |
|---|---|
| paymentDetails-r17 | SEQUENCE { |
| price-r17 | INTEGER (1..maxPrice- |

r17),

| | |
|---|---|
| currency-r17 | ENUMERATED {Euro, USD, ...}, |
| paymentMethods-r17 | SEQUENCE { |

| | |
|---|---|
| creditCard | ENUMERATED |

| | | |
|---|---|---|
| {true} | OPTIONAL, | -- Need R |

| | |
|---|---|
| debitCard | ENUMERATED |

| | | |
|---|---|---|
| {true} | OPTIONAL, | -- Need R |

| | |
|---|---|
| paypal | ENUMERATED |

| {true} | OPTIONAL, | -- Need R |
|---|---|---|
| | | ... |
| | } OPTIONAL, | -- Need R |

```
    ...
  }
  HRSN-r17 ::=
```

OCTET STRING (SIZE (1.. maxHRSN-Len-r17))

SIBXY field descriptions

hrsn
Indicates the human readable service name (HRSN).
price
Indicates the price in “cents” of a given currency.
currency
Indicates the currency.
paymentMethods
Indicates the supported payment methods.

ASN.1 example for HRSI broadcast.

Broadcasting name indication exemplified as HRSI in system information:

The HRSIs and mapping between HRSIs and type indication may be provided via the SI. The form of the mapping may depend on how the type of service is indicated for a GID or a network, i.e. which of the options a-c above that is used.
If option ‘a’ is used to indicate the service type for a GID, one HRSI can be included together with each GID list.
If option ‘b’ is used to indicate the type of service for a GID, one HRSI can be included for each GID in the GID list. If the encoding of the type of service into the GID follows a pre-defined format, it may be possible to only include one HRSI per type of service rather than one HRSI per GID, thereby reducing the amount of signaling. This would for example be possible if say the first n bits in the GID represent the type of service in which case it would be 2ⁿ possible types of service.
If option ‘c’ is used to indicate the type of service for a GID, one HRSI can be included for each type of service represented by the bits in the bitmap.
If option ‘d’ is used to indicate type of service for a network, one HRSI can be included for each type of service.

In options ‘a’-‘c’ above, the HRSI may either be included in the same SIB containing the GID list or it may be included in a separate SIB. Alternatively, the HRSI may also be included in a new list in SIB10 that may already include HRNNs for NPNs. If the HRSIs are provided in a separate SIB some form of pointer or reference will be needed to establish the link between the GID list (option ‘a’), GID (option ‘b’), or bits in the service type bitmap (option ‘c’). For option ‘b’, in particular, it may be beneficial to include the HRSI in separate SIB since there may be many GIDs sharing the same HRSI. For option ‘d’, the HRSI may typically be included in a separate SIB than the SIB containing the network list. It may either be a new SIB or included in a new list in SIB10.

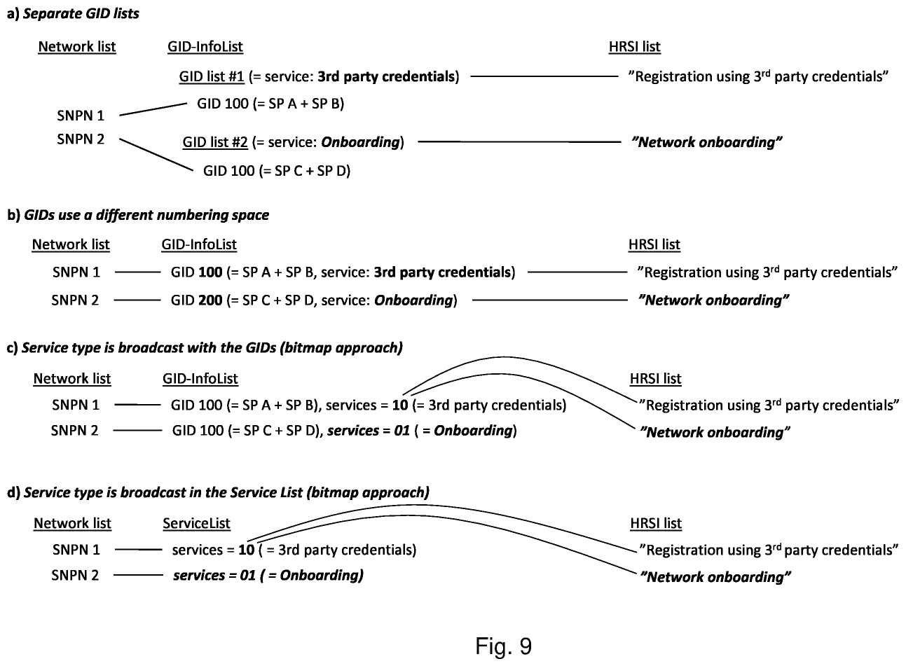

The HRSI provisioning via system information for the options ‘a’-‘d’ is illustrated in FIG. 9.

FIG. 9 shows options for indicating HRSI.

Below is it shown an ASN.1 example which broadcasts which services are supported by a network. Each service can be associated with the name indication, for which the ASN.1 encoding has been exemplified above. For convenience, the service (types) list and the HRSI list are shown as part of the same SIB. However, they can also be provided in separate SIBs. It would also be possible to include the service list in SIB1 and the HRSI list in SIB10 if e.g. the service information is only applicable to NPNs.

-- ASN1START
-- TAG-SIBXY-START

| | |
|---|---|
| SIBXY-r17 ::= | SEQUENCE { |
| servTypesList-r17 | ServTypesList-r17 |

OPTIONAL, -- Need R

| | |
|---|---|
| hrsi-List-r17 | HRSI-List-r17 |
| lateNonCriticalExtension | OCTET STRING OPTIONAL, |

...
}

| | |
|---|---|
| ServTypesList-r17 ::= | SEQUENCE (SIZE (1..maxNetworks-r17)) OF ServTypes-r17 |
| ServTypes-r17 ::= | BIT STRING (SIZE (maxServTypes-r17)) |
| HRSI-List-r17 ::= | SEQUENCE (SIZE (1..maxServTypes-r17)) OF HRSI-r17 |

-- TAG-SIBXY-STOP
-- ASN1STOP

SIBXY field descriptions

```
  hrsi-List
  Provides the Human Readable Service Information. The n-th entry of
the hrsi-List corresponds to the n-th bit listed in Table.
  servTypesList
  The same amount of ServTypes elements as the number of networks
  in SIB 1 are included.
The n-th entry of servTypesList contains the bitmap with the supported
service types of the n-th network of SIB1. The service types are defined
in Table.
```

ASN.1 example for broadcast of supported service types and HRSI.

Table 1 defines the Service Type mapping. Bit 1 is the leftmost (most significant) bit.

TABLE 1
Service Type mapping.

| Bit | Service Type |
|---|---|
| 1 | Registration using 3^{rd} party credentials |
| | If set to 1: Registration using 3^{rd} party credentials |
| | is supported. |
| 2 | UE onboarding |
| | If set to 1: UE onboarding is supported |
| 3 - | Not used in this release of the specification, and |
| maxServTypes | shall be ignored by UE. |

Preconfiguring the name indication, exemplified as HRSI, in the UE 10:

Both the HRSI and the mapping between HRSIs and types of services may be preconfigured in the UE 10 and may possibly be updated in the UE 10. Similar to the previous embodiment, the form of the mapping may depend on how the type of service is indicated for a GID, i.e. which of the options a-d that is used.
If option ‘a’ or ‘c’ is used to indicate the type of service for a GID, one HRSI can be preconfigured for each of the types of services represented by the different GID lists (option ‘a’) or the bits in the bitmap (option ‘c’).
If option ‘a’ or ‘c’ is used to indicate the type of service for a GID, one HRSI can be preconfigured for each GID value. If the encoding of the type of service into the GID follows a pre-defined format, it may be possible to only include one HRSI per type of service rather than one HRSI per GID. This would for example be possible if e.g. the last n bits in the GID represent the service type in which case it would be 2ⁿ possible service types. If the 8 bit long NID Code (for assignment mode 0) is replaced by the GID service type, n would equal to 8 bits.
If option ‘d’ is used one HRSI can be preconfigured for each type of service value per network.

If no HRSI has been pre-configured for a type of service a default HRSI could be used instead, e.g. “Unknown service”.

It is also possible to combine the pre-configured approach with the broadcasting approach. For example, the pre-configured value could be used as fallback if no HRSI is provided via system information.

UE behavior using the name indication such as the HRSI:

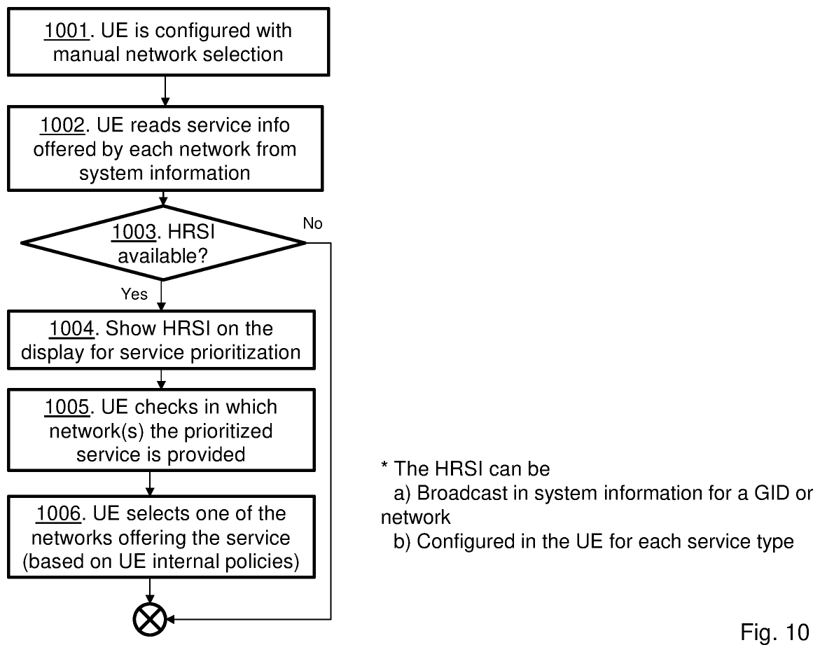

The UE behavior using HRSI from the system information or as part of the UE (pre-)configuration is illustrated in FIG. 10. The UE 10 may be configured with a GID and when performing network selection, it can scan and detect available networks. FIG. 10 shows a UE behavior for using HRSI for network selection.

Action 1001. The UE 10 may be configured with manual network selection.

Action 1002. The UE 10 may read service information offered by each network from the SI.

Action 1003. The UE 10 checks whether the name indication, e.g., the HRSI, is available for the service information.

Action 1004. That being the case, the UE 10 displays the HRSI on the display for service selection or prioritization.

Action 1005. The UE 10 checks in which network(s) the prioritized service is provided.

Action 1006. The UE 10 selects one of the networks offering the service (based on internal policies) and the name indication.

Note, instead of showing the HRSI on the display to the user of the UE 10, the UE 10 may use user configured preferences on what policies to apply for selection e.g. preferred services, preferences on price and payment methods etc. In such case, the UE 10 can perform a pseudo-manual selection without requiring user interaction or only a consent for selecting the network as per the pre-configured preferences.

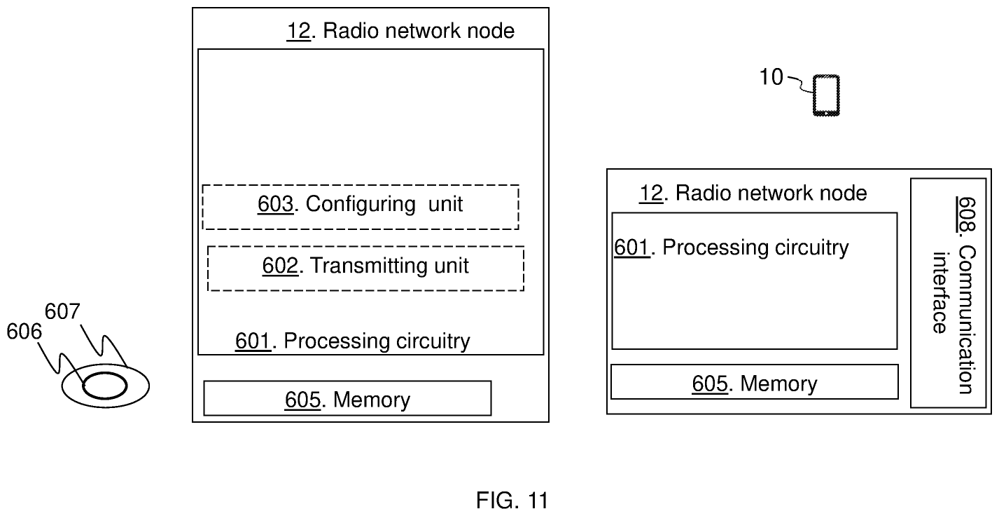

FIG. 11 is a block diagram depicting the radio network node 12 for handling communication in the wireless communications network 1 according to embodiments herein.

The radio network node 12 may comprise processing circuitry 601, e.g. one or more processors, configured to perform the methods herein.

The radio network node 12 may comprise a transmitting unit 602, e.g. a transmitter or a transceiver. The radio network node 12, the processing circuitry 601 and/or the transmitting unit 602 may be configured to transmit or broadcast the SI with the type indication and/or the GID, wherein the type indication indicates the type of service offered by the one or more networks identified by the GID. The SI may comprise the mapping and/or the name indication. The name indication may comprise human readable service information, and/or additional characteristics such as start and end time, price, payment options, rating, etc.

The radio network node 12 may comprise a configuring unit 603, e.g. a transmitter or a transceiver. The radio network node, the processing circuitry 601 and/or the configuring unit 603 is configured to configure the UE 10 with the mapping wherein the mapping maps the name indication such as the HRSI, to the GID and/or the type indication of the type of service offered by the one or more networks identified by the GID.

The radio network node 12 may comprise a memory 605. The memory 605 comprises one or more units to be used to store data on, such as data packets, mapping, name indication, type indication, GIDs, networks, mobility events, measurements, sizes related to types of data transmissions, events and applications to perform the methods disclosed herein when being executed, and similar. Furthermore, the radio network node 12 may comprise a communication interface 608 such as comprising a transmitter, a receiver, a transceiver and/or one or more antennas.

The methods according to the embodiments described herein for the radio network node 12 are respectively implemented by means of e.g. a computer program product 606 or a computer program, comprising instructions, i.e., software code portions, which, when executed on at least one processor, cause the at least one processor to carry out the actions described herein, as performed by the radio network node 12. The computer program product 606 may be stored on a computer-readable storage medium 607, e.g. a disc, a universal serial bus (USB) stick or similar. The computer-readable storage medium 607, having stored thereon the computer program product, may comprise the instructions which, when executed on at least one processor, cause the at least one processor to carry out the actions described herein, as performed by the radio network node 12. In some embodiments, the computer-readable storage medium may be a transitory or a non-transitory computer-readable storage medium. Thus, embodiments herein may disclose a radio network node 12 for handling communication in a wireless communications network, wherein the radio network node 12 comprises processing circuitry and a memory, said memory comprising instructions executable by said processing circuitry whereby said radio network node 12 is operative to perform any of the methods herein.

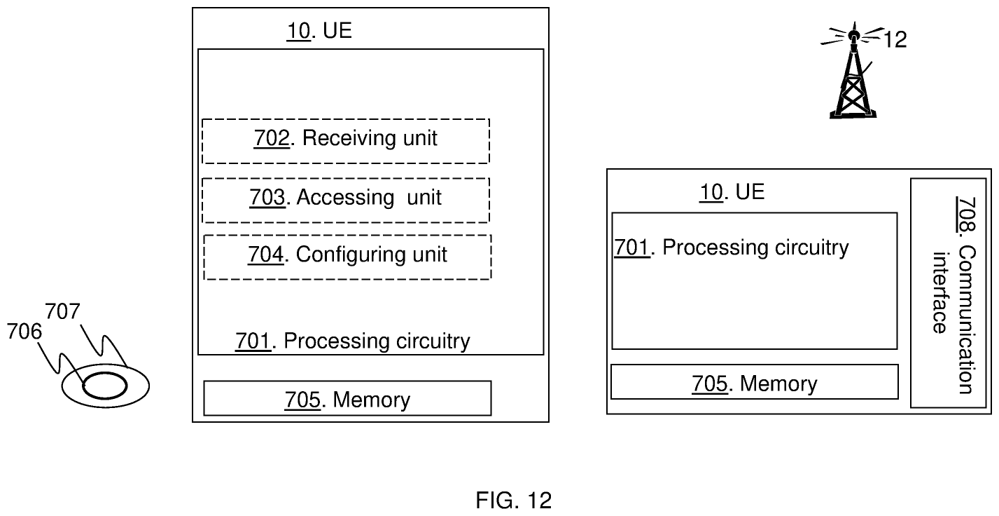

FIG. 12 is a block diagram depicting the UE 10 for handling communication in the wireless communications network 1 according to embodiments herein.

The UE 10 may comprise processing circuitry 701, e.g. one or more processors, configured to perform the methods herein.

The UE 10 may comprise a receiving unit 702, e.g., a reader, a receiver or a transceiver. The UE 10, the processing circuitry 701 and/or the receiving unit 702 may be configured to receive the SI with the type indication and/or the GID. The SI may further comprise the SI comprises the mapping and/or the name indication. The name indication may comprise human readable service information, and/or additional characteristics such as start and end time, price, payment options, rating, etc.

The UE 10 may comprise an accessing unit 703, e.g., a transmitter or a transceiver. The UE 10, the processing circuitry 701 and/or the accessing unit 703 may be configured to access the network based on the name indication. The UE 10, the processing circuitry 701 and/or the accessing unit 703 may be configured to use the type indication, the GID and/or the name indication to access a network. The UE 10, the processing circuitry 701 and/or the accessing unit 703 may be configured to use the type indication, the GID and/or the name indication by selecting one of the networks based on the GID and/or the type indication, and the mapped name indication. The one of the networks may be manually selected based on the name indication. For example, the UE 10, the processing circuitry 701 and/or the accessing unit 703 may be configured to select one of the networks it is allowed to access, based on the GID(s) the UE 10 is configured with and type indication and the mapped name indication. For example, the UE 10, the processing circuitry 701 and/or the accessing unit 703 may be configured to select network which corresponds to the type indication and HRSI, for example, manually selected or selected based on configured preferences.

The UE 10 may comprise a configuring unit 704. The UE 10, the processing circuitry 701 and/or the configuring unit 704 is adapted to be configured (preconfigured or configured from the radio network node 12) with the mapping, wherein the mapping maps the name indication such as the HRSI, to the GID and/or the type indication of a type of service offered by the one or more networks identified by the GID.

The UE 10 may comprise a memory 705. The memory 705 comprises one or more units to be used to store data on, such as data packets, grants, name indication(s), type indication(s), indices, bitmap, indications, GIDs, mobility events, measurements, events and applications to perform the methods disclosed herein when being executed, and similar. Furthermore, the UE 10 may comprise a communication interface 708 such as comprising a transmitter, a receiver, a transceiver and/or one or more antennas.

The methods according to the embodiments described herein for the UE 10 are respectively implemented by means of e.g. a computer program product 706 or a computer program, comprising instructions, i.e., software code portions, which, when executed on at least one processor, cause the at least one processor to carry out the actions described herein, as performed by the UE 10. The computer program product 706 may be stored on a computer-readable storage medium 707, e.g. a disc, a universal serial bus (USB) stick or similar. The computer-readable storage medium 707, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a wireless communications network, wherein the UE 10 comprises processing circuitry and a memory, said memory comprising instructions executable by said processing circuitry whereby said UE 10 is operative to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

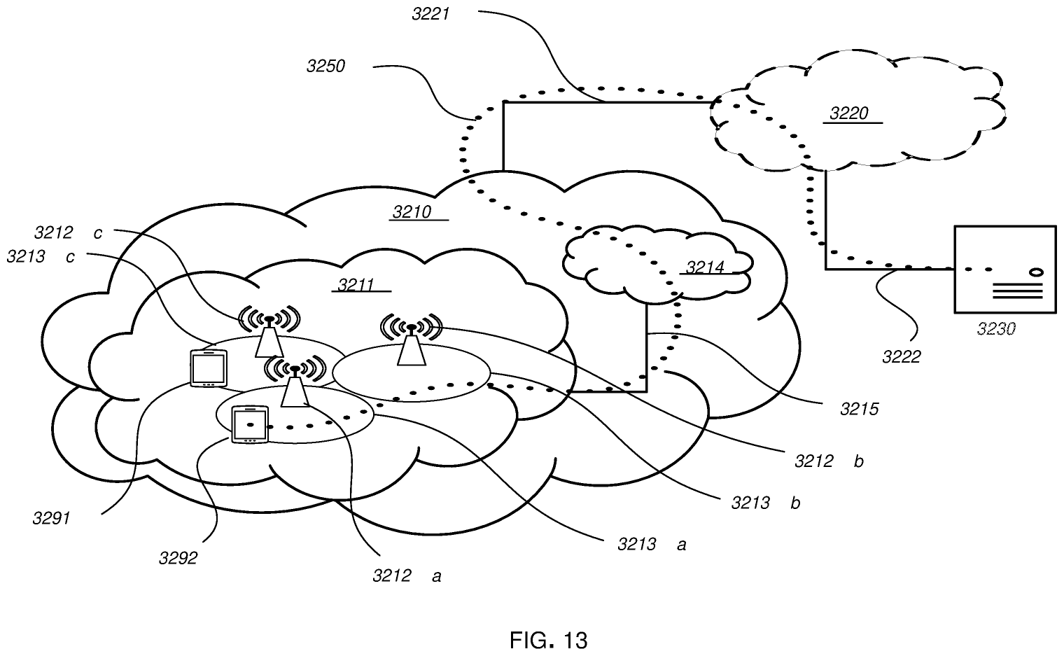

With reference to FIG. 13, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10 and relay UE 13, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

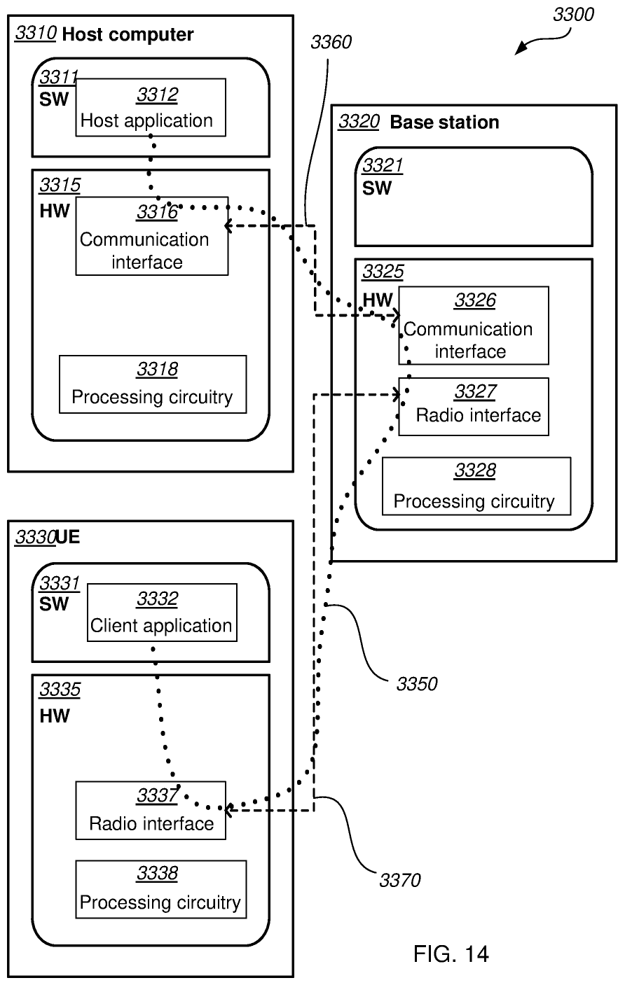

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since SI is transmitted more efficiently and thereby provide benefits such as reduced user waiting time, and better responsiveness since interference is reduced.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

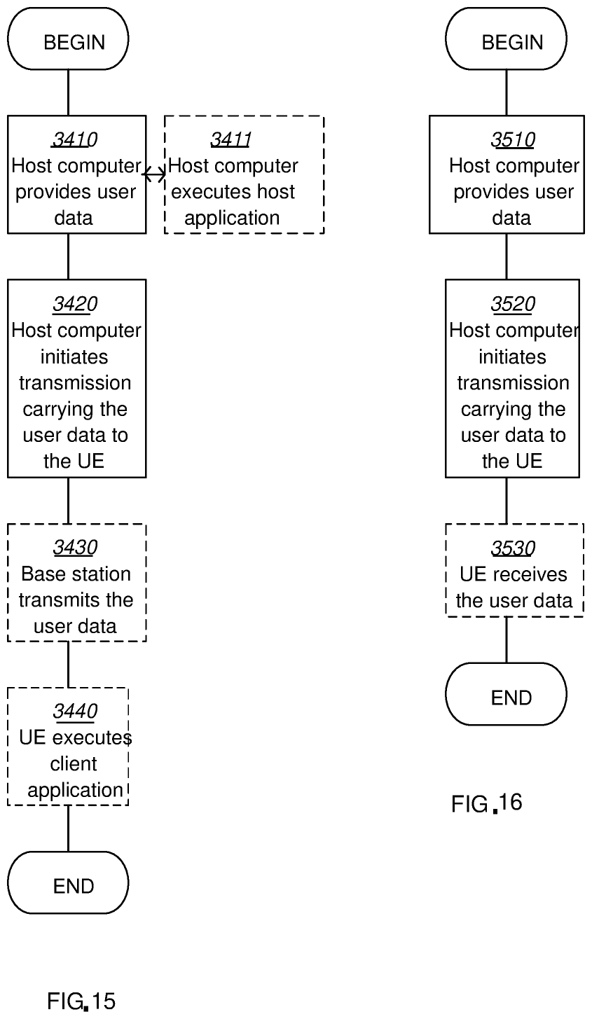

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

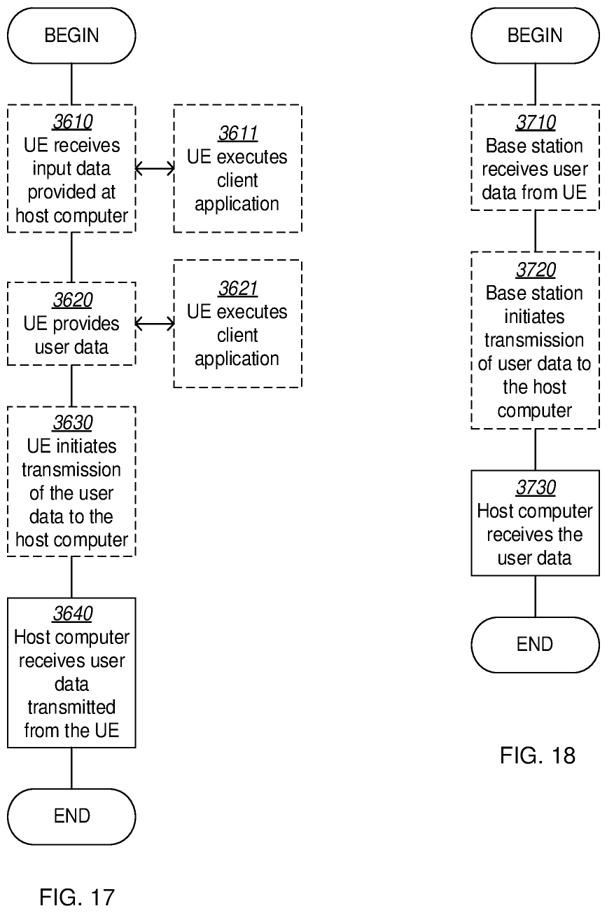

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

| Abbreviation | Explanation |
|---|---|
| 5GC | 5th Generation Core Network |
| BSR | Buffer Status Report |
| CORESET | Control Resource Set |
| CN | Core Network |
| CSS | Common Search Space |
| DCI | Downlink Control Indicator |
| DVT | Data Volume Threshold |
| EDT | Early Data Transmission |
| MIB | Master Information Block |
| Msg | Message |
| NR | New Radio |
| PBCH | Physical Broadcast Channel |
| PDCCH | Physical Downlink Control Channel |
| PDSCH | Physical Downlink Shared Channel |
| PRACH | Physical Random Access Channel |
| RACH | Random Access Channel |
| RAR | Random Access Response |
| SDT | Small Data Transmission |
| SSB | Synchronization Signal Block |

### REFERENCES

1. 3GPP TR 23.700-07 v1.2.0: Study on enhanced support of non-public networks
2. 3GPP TS 38.331 v16.3.1: NR; Radio Resource Control (RRC); Protocol specification
3. 3GPP TS 23.501 v16.7.0: System architecture for the 5G System (5GS)
4. 3GPP TS 38.300 v16.4.0: NR; NR and NG-RAN Overall description; Stage-2
5. 3GPP TS 38.401 v16.4.0: NG-RAN; Architecture description
6. 3GPP TR 23.700-07 v2.0.0: Study on enhanced support of non-public networks

1-28. (canceled)

29. A method performed by a radio network node for handling communication in a wireless communications network, the method comprising:
configuring a user equipment (UE) with a mapping, wherein the mapping maps a name indication to at least one of a group identity (GID) and a type indication of a type of service offered by one or more networks identified by the GID.

30. The method according to claim 29, further comprising transmitting system information (SI) comprising at least one of the GID and the type indication.

31. The method according to claim 30, wherein the SI further comprises at least one of the mapping and the name indication.

32. The method according to claim 29, wherein the name indication comprises human readable service information.

33. A method performed by a user equipment (UE) for handling communication in a wireless communications network, the method comprising:
configuring the UE with a mapping, wherein the mapping maps a name indication to at least one of a group identity (GID) and a type indication of a type of service offered by one or more networks identified by the GID.

34. The method according to claim 33, further comprising receiving system information (SI) comprising at least one of the GID and the type indication.

35. The method according to claim 34, wherein the SI further comprises at least one of the mapping and the name indication.

36. The method according to claim 35, further comprising using at least one of the type indication, the GID, and the name indication to access a network.

37. The method according to claim 36, wherein using the at least one of the type indication, the GID, and the name indication to access a network comprises selecting one of the networks based on the GID and/or the type indication, and the mapped name indication.

38. The method according to claim 37, wherein the one of the networks is manually selected based on the name indication.

39. The method according to claim 33, wherein the name indication comprises human readable service information.

40. A radio network node for handling communication in a wireless communications network, wherein the radio network node is configured to:
configure a user equipment (UE) with a mapping, wherein the mapping maps a name indication to at least one of a group identity (GID) and a type indication of a type of service offered by one or more networks identified by the GID.

41. The radio network node according to claim 40, wherein the radio network node is further configured to transmit system information (SI) comprising at least one of the type indication and the GID.

42. The radio network node according to claim 41, wherein the SI further comprises at least one of the mapping and the name indication.

43. The radio network node according to claim 40, wherein the name indication comprises human readable service information.

44. A user equipment (UE) for handling communication in a wireless communications network, wherein the user equipment is configured to be configured with a mapping, wherein the mapping maps a name indication to at least one of a group identity (GID) and a type indication of a type of service offered by one or more networks identified by the GID.

45. The UE according to claim 44, wherein the UE is further configured to receive system information (SI) comprising at least one of the type indication and the GID.

46. The UE according to claim 45, wherein the SI further comprises at least one of the mapping and the name indication.

47. The UE according to claim 46, wherein the UE is further configured to use one or more of the type indication, the GID, and the name indication to access a network.

48. The UE according to claim 47. wherein the UE is configured to use the one or more of the type indication, the GID, and the name indication by selecting one of the networks based on the GID and/or the type indication and the mapped name indication.
